(19) United States
(12) Patent Application Publication
(10) Pub. No.: US 2014/0246461 A1
(43) Pub. Date: Sep. 4, 2014

(54) REMOVABLE NEOPRENE SLEEVE FOR AN AIRPOT BEVERAGE DISPENSER

(71) Applicant: David Coplin, Huntington Beach, CA (US)

(72) Inventor: David Coplin, Huntington Beach, CA (US)

(21) Appl. No.: 14/275,681

(22) Filed: May 12, 2014

Related U.S. Application Data
(63) Continuation-in-part of application No. 29/441,466, filed on Jan. 4, 2013, now Pat. No. D704513.

(51) Int. Cl. B05B 11/00

(52) U.S. Cl. CPC B05B 11/0037
USPC 222/183

(57) ABSTRACT

In accordance with one aspect of the invention, a neoprene sleeve is provided that is sized to fit an airpot dispenser so that the sleeve extends between the bottom end of the dispenser and the dispensing portion of the airpot dispenser. The neoprene sleeve is resilient and covers the outer finish of the airpot dispenser, thereby protecting the dispenser by inhibiting (e.g., preventing) dents and scratches to the outer surface of the dispenser while covering up any existing dents and scratches so that they are not noticeable to the user.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

1. Field

The invention relates to airpot beverage dispensers, and more particularly to removable sleeves for airpot beverage dispensers

2. Description of the Related Art

Airpot dispensers are used commonly in the catering business to dispense beverages (e.g., coffee, hot water). The airpot dispensers can have a thermos container within them and use vacuum insulation to insulate the contents of the airpot dispenser and maintain their temperature.

Airpot dispensers usually have an outer surface or finish made of brushed or polished stainless steel. However, the airpot dispensers can become dented or scratched during use, which makes them less attractive to use (e.g., at a catering event, in a coffee/tea shop), even while the airpot is still operable to dispense liquids and the internal portion of the airpot dispenser remains intact.

### SUMMARY

Accordingly, there is a need to protect existing airpot dispensers that protects the dispenser by inhibiting (e.g., prevents) the dispensers from being dented or scratched during use and also covering up any existing dents or scratches on the airpot dispenser, thereby extending the working life of the airpot dispenser and therefore decreasing potential impact on landfill from disposal of dented and unsightly airpot dispensers.

In accordance with one aspect of the invention, a neoprene sleeve is provided that is sized to fit an airpot dispenser so that the sleeve extends between the bottom end of the dispenser and the dispensing portion of the airpot dispenser. The neoprene sleeve is resilient and covers the outer finish of the airpot dispenser, thereby protecting the dispenser by inhibiting (e.g., preventing) dents and scratches to the outer surface of the dispenser while covering up any existing dents and scratches so that they are not noticeable to the user.

In accordance with another aspect of the invention, a sleeve is provided that is sized to fit an airpot dispenser so that the sleeve extends between the bottom end of the dispenser and the dispensing portion of the airpot dispenser. The sleeve is of a resilient material and covers the outer finish of the airpot dispenser, thereby protecting the dispenser by inhibiting (e.g., preventing) dents and scratches to the outer surface of the dispenser while covering up any existing dents and scratches so that they are not noticeable to the user.

In accordance with another aspect of the invention, in combination are provided an airpot dispenser for dispensing a beverage and a removable sleeve of resilient material configured to resiliently fit over an outer surface of the airpot dispenser to thereby protect the dispenser from suffering dents, scratches or nicks. The sleeve is also configured to camouflage existing dents, nicks and scratches on the airpot dispenser, the sleeve having an open top end and an open bottom end.

In accordance with another aspect of the invention, a removable sleeve for use with an airpot beverage dispenser is provided. The sleeve comprises a sleeve body of a single layer of neoprene, where the edges of said layer are joined together by a hot weld seam that extends along the length of the sleeve body, the sleeve body having an open top end and an open bottom end. The sleeve body is configured to removably and resiliently fit over an airpot beverage dispenser and to extend between a bottom end of the airpot dispenser and the dispensing portion of the airpot dispenser. The sleeve body is configured to protect the dispenser from suffering dents, scratches or nicks and also configured to camouflage existing dents, nicks and scratches on the airpot dispenser.

### BRIEF DESCRIPTION OF THE DRAWINGS

FIG. 1 is a perspective view of one embodiment of a removable sleeve for an airpot beverage dispenser with the sleeve mounted on the airpot beverage dispenser;

FIG. 2 is a front view of the sleeve;

FIG. 3 is a rear view of the sleeve, showing a seam thereof;

FIG. 4 is a left side view of the sleeve, the right side view being a mirror image;

FIG. 5 is a top view of the sleeve, the bottom view being identical;

FIG. 6 is a front view of the sleeve with a label “regular” shown in broken lines;

FIG. 7 is a front view of the sleeve with a label “decaf” shown in broken lines; and

FIG. 8 is a front view of the sleeve with a tuxedo design shown in broken lines.

### DETAILED DESCRIPTION

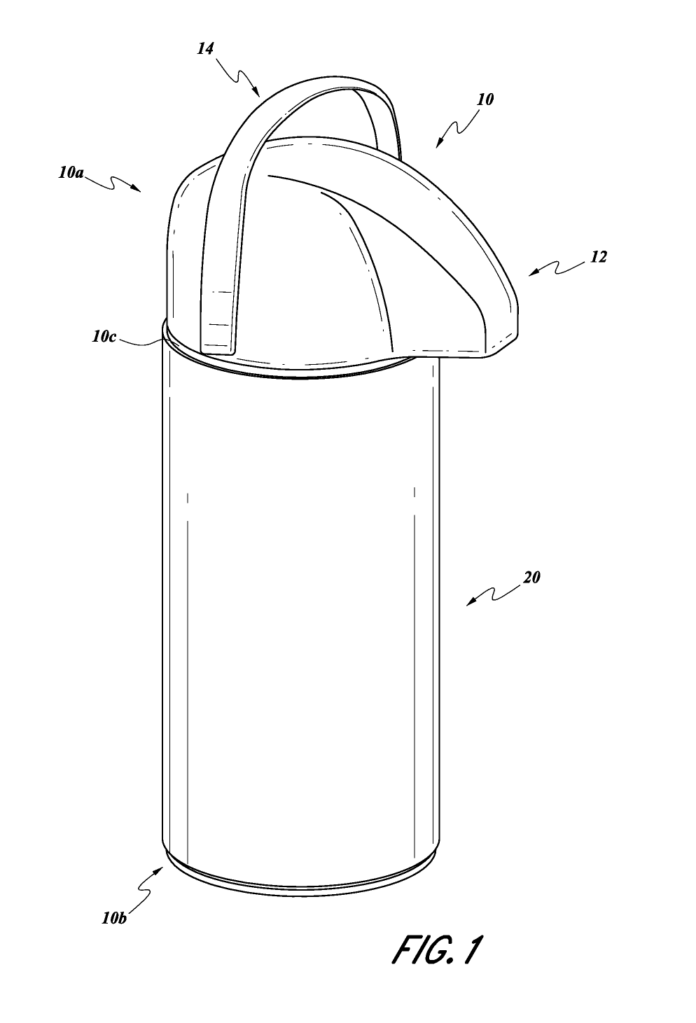

FIG. 1 shows one embodiment of an airpot dispenser 10 that extends from a proximal end 10a to a distal end 10b. The airpot dispenser 10 can have a dispensing portion or spout 12 and optionally have a handle 14. The airpot dispenser 10 can have an outer surface 10c that in some embodiments can be generally cylindrical. In other embodiments, the outer surface 10c can be tapered (e.g., a tapered cylinder that has a larger diameter at the distal end 10b than at the proximal end 10a).

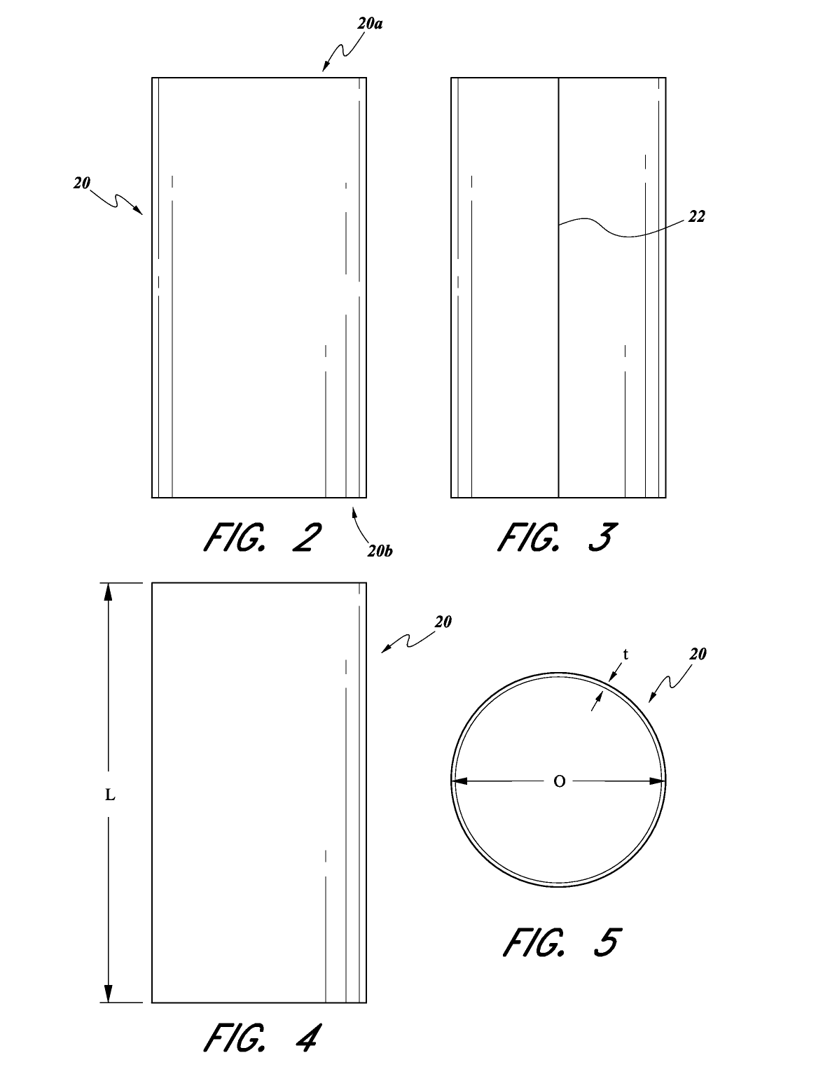

FIGS. 2-5 show one embodiment of a sleeve 20 for use with an airpot dispenser 10. The sleeve 20 can be removably disposed on the outer surface 10c of the airpot dispenser 10, as shown in FIG. 1. In one embodiment, the sleeve 20 is made of a resilient material, such as neoprene. The sleeve 20 can be generally cylindrical and extend along a length L from an open top end 20a to an open bottom end 20b. In one embodiment, the length can be between about 10 in. and about 13 in. tall, for example about 11 inches, about 12 inches, etc. The sleeve 20 can have an inner diameter O and a thickness t. In one embodiment the inner diameter O can be between about 5 in. and about 7 inches. In one embodiment, the sleeve 20 is cylindrical and has the same inner diameter O along its length L. In another embodiment, the inner diameter O at the bottom of the sleeve 20 can differ from the inner diameter O at the top of the sleeve 20. For example, in one embodiment, the inner diameter O at the base of the sleeve 20 can be about 6 in. and the inner diameter O at the top of the sleeve 20 can be about 5.5 in. In one embodiment, the thickness t can be between about 1/16 in. and about 1/2 in., such as about 1/8 inches. The sleeve 20 can be made of a single layer of resilient material, such as neoprene, with a seam (e.g. hot weld seam) 22 joining the edges of said single layer of material. The single layer of material when laid out flat can have a bottom edge between about 15 in. and about 20 in. long, such as about 18 in. The single layer of material when laid out flat can have a top edge between about 15 in. and about 20 in. long, such as about 17 in.

Advantageously, when placed on the airpot dispenser 10, the sleeve 20 protects the outer surface 10c of the dispenser and inhibits (i.e., prevents) dents, nicks or scratches to the outer surface 10c, as well as covers or camouflages any existing dents, nicks or scratches on the outer surface 10c of the airpot dispenser 10, thereby extending the working life of the airpot dispenser 10 and therefore decreasing potential impact on landfill from disposal of dented and unsightly airpot dispensers. Therefore, the sleeve 20 advantageously protects the airpot dispenser 10 from dents, scratches and nicks, as well as protects the inner thermos portion of the airpot dispenser 10. In one embodiment, the resilient nature of the sleeve 20 can allow the sleeve to cover up any existing dents on the airpot sleeve 10 while presenting a generally smooth cylindrical outer surface to the user, such that the user does not notice the existing dents on the airpot dispenser 10. Additionally, the resilient nature of the sleeve 20 allows the sleeve 20 stretch over the body of the airpot dispenser 10, thereby allowing the sleeve 20 to fit dispensers of various outer diameters and shapes (e.g., cylindrical airpot dispensers, tapered airpot dispensers having a larger diameter at the bottom and a smaller diameter at the top of the dispenser). The outer surface of the sleeve 20 can be substantially smooth (e.g., continuous), such that the sleeve 20 presents a smooth outer surface (e.g., cylindrical outer surface) to the user when fitted over the body of the airpot dispenser.

Advantageously, the sleeve 20 is removable, which allows the sleeve 20 to be changed out and replaced (e.g., when the user wants to wash the sleeve 20, or when the user wants to change the sleeve depending on the beverage being served, such as Decaf or Regular coffee).

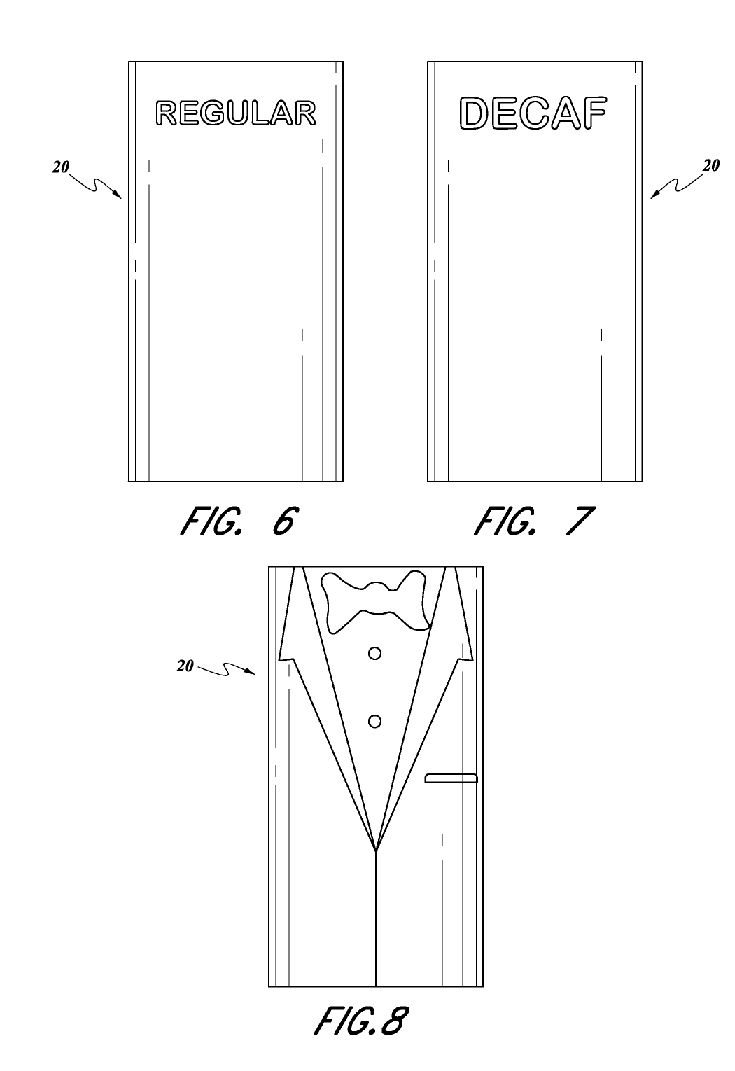

FIGS. 6-7 show different embodiments of the sleeve 20 with labels indicating the nature of the beverage dispensed from the airpot dispenser 10 (e.g., Regular coffee, Decaffeinated coffee), or can have different designs or insignia (e.g., a tuxedo) depending on the event for which the airpot dispensers 10 and sleeves 20 are being used for.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a sub combination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. In combination, an airpot dispenser for dispensing a beverage and a removable sleeve of resilient material configured to resiliently fit over an outer surface of the airpot dispenser to thereby protect the dispenser from suffering dents, scratches or nicks and also configured to cover existing dents, nicks and scratches on the airpot dispenser, the sleeve having an open top end and an open bottom end.

2. The combination of claim 1, wherein the sleeve is a neoprene sleeve.

3. The combination of claim 1, wherein the sleeve is made of a single layer of material joined together at a seam.

4. The combination of claim 3, wherein the seam is a hot weld seam.

5. The combination of claim 1, wherein the sleeve extends between the bottom end of the airpot dispenser and the dispensing portion of the airpot dispenser.

6. The combination of claim 1, wherein the sleeve is configured to fit over an airpot dispenser having a cylindrical body.

7. The combination of claim 6, wherein the sleeve presents a substantially smooth cylindrical outer surface to a user when fitted over the airpot dispenser.

8. The combination of claim 1, wherein the sleeve can have a label on an outer surface thereof to identify the contents of the airpot dispenser.

9. A removable sleeve for use with an airpot beverage dispenser, comprising:
a sleeve body of a single layer of neoprene, where the edges of said layer are joined together by a hot weld seam that extends along the length of the sleeve body, the sleeve body having an open top end and an open bottom end, the sleeve body configured to removably and resiliently fit over an airpot beverage dispenser and to extend between a bottom end of the airpot dispenser and the dispensing portion of the airpot dispenser, the sleeve body configured to protect the dispenser from suffering dents, scratches or nicks and also configured to cover existing dents, nicks and scratches on the airpot dispenser.

10. The sleeve of claim 9, wherein the sleeve body is cylindrical.

11. The sleeve of claim 9, wherein the sleeve body is configured to fit over an airpot dispenser having a cylindrical body.

12. The sleeve of claim 11, wherein the sleeve presents a substantially smooth cylindrical outer surface to a user when fitted over the airpot dispenser.

13. The sleeve of claim 9, wherein the sleeve can have a label on an outer surface thereof to identify the contents of the airpot dispenser.
